(19) United States
(12) Patent Application Publication
(10) Pub. No.: US 2024/0359432 A1
(43) Pub. Date: Oct. 31, 2024

(54) SOUND DAMPING MULTI-LAYERED METALLIC SHEET, ARTICLES INCLUDING SAME, AND METHODS THEREOF

(71) Applicant: Material Sciences Corporation, Canton, MI (US)

(72) Inventors: Bryan Joseph TULLIS, Commerce Twp, MI (US); Karl D. KARLSON, West Bloomfield, MI (US); Matthew MURPHY, Canton, MI (US)

(21) Appl. No.: 18/687,594

(22) PCT Filed: Oct. 28, 2022
(86) PCT No.: PCT/US2022/048130

§ 371 Date: Feb. 28, 2024

Related U.S. Application Data
(60) Provisional application No. 63/272,837, filed on Oct. 28, 2021.

(51) Int. Cl. B32B 15/08; B32B 3/06; B32B 3/26; B32B 15/18; B32B 33/00; B32B 37/24; B32B 38/00

(52) U.S. Cl. CPC B32B 15/08; B32B 3/06; B32B 3/266; B32B 15/18; B32B 33/00; B32B 37/24; B32B 2037/243; B32B 2038/0076; B32B 2255/06; B32B 2255/26; B32B 2264/101; B32B 2264/107; B32B 2264/2032; B32B 2264/305; B32B 2305/74; B32B 2307/102; B32B 2307/538; B32B 2307/7376; B32B 2307/752; B32B 2311/30; B32B 2605/08

(57) ABSTRACT

The teachings herein relate to sound damping materials and particularly to sound damping materials for castings. The sound damping material includes a surface layer including an elastomer and a filler. Preferably the filler includes glass or ceramic beads. The surface layer preferably has a textured surface for contacting with the casting. Preferably the filler has a diameter that provides or contributes to the textured surface. For example, a portion of the filler may have a diameter that is greater than the average thickness of the surface layer. The sound damping material includes one or more metallic layers, preferably for applying a force to a surface of the casting. The sound damping material preferably includes two metallic layers that are separated by a core polymeric layer.

### PRIORITY CLAIM

The present application claims priority to U.S. Provisional patent application Ser. No. 63/272,837, filed on Oct. 28, 2021, the contents of which are incorporated herein by reference in its entirety.

### FIELD

The teachings herein relate to composite materials having improved sound damping performance, devices including the composite materials and related methods. The composite material preferably includes a polymeric core layer. The composite materials preferably include a surface layer includes an elastomer having a glass transition temperature of about 10° C. or less and/or a crystallinity of about 5 percent or less.

### BACKGROUND

There continues to be a need for new materials and articles for sound damping of components that generate or transmit sound, particularly components that include a casting (e.g., a metal casting).

Many sound damping materials use foams, or other materials having voids and or porous structures. However, such materials may deteriorate and/or lose sound damping performance over time and/or at elevated temperatures.

There is a need for sound damping materials having one or more of the following properties: the sound damping performance does not deteriorate over time; the sound damping performance does not deteriorate at elevated temperatures; the sound damping material is light weight; the sound damping material can be used on castings that are not machined to a smooth surface; the sound damping material is effective at reduce peak sound in the 400 Hz to 800 Hz range; the sound damping material is corrosion resistant; the sound damping material has good adhesion; the sound damping material has good resistance to humidity, acids, base, oil, or any combination thereof; the sound damping material applies pressure over a large portion of the contact area with the casting; or any combination thereof. There is a similar need for sound damping articles having the same properties. There is also a need for methods for making new sound damping materials.

### SUMMARY

One or more of the aforementioned needs are achieved with the sound damping material and sound damping articles according to the teachings herein. In particular, applicant has identified composite structures that provide surprising sound damping performance while being generally light weight, easy to manufacture and useful in a variety of applications with different temperature and environmental exposures.

One aspect of the teachings herein is directed at a sound damping article for attaching to a casting comprising a multi-layer composite including: a first metallic layer; a second metallic layer; one or more core layers interposed between the first metallic layer and the second metallic layer so that direct contact between the first metallic layer and the second metallic layer is avoided, wherein each of the one or more core layers is formed of a polymeric material; and a surface layer (i.e, damping surface) for contacting the casting, wherein the surface layer is an outside layer over the first metallic layer or the second metallic layer, wherein the surface layer includes an elastomeric composition having a glass transition temperature of about 10° C. or less, a crystallinity of about 5 percent or less at 23° C., or both.

Another aspect of the teachings herein is directed at a sound damping article, wherein the sound damping article is formed of a composite material, the sound damping article is configured for attaching to a casting, the composite material includes a metallic layer (preferably two or more metallic layers) and a surface layer including an elastomer and glass or ceramic beads, wherein the sound damping article results in a reduction in the maximum value of the noise transfer function in the frequency range of 400 Hz to 800 Hz by about 10 dB or more at one or more of the following temperatures: about 20° C., about 50° C., about 60° C., about 70° C., about 80° C., or about 90° C.

The sound damping article according to the teachings herein may be characterized by one or any combinations of the following features: the elastomeric composition includes an elastomer; the elastomer is an ethylene copolymer (e.g., having a comonomer that is an olefin and/or a comonomer that includes one or more heteroatoms), a polyisoprene, a polybutadiene, an ethylene propylene diene rubber, a silicone elastomer, a fluoroelastomer, a natural rubber, a styrene-butadiene block copolymer, a polyurethane elastomer, an polyacrylic rubber, an epichlorohydrin rubber, polyether block amide, an ethylene-vinyl acetate rubber, a chloroprene rubber, a halogenated butyl rubber, a hydrogenated nitrile rubber, a nitrile rubber, a copolymer thereof, or any combination thereof; the elastomer is free of any melting temperature or glass transition temperature of about 35° C. or more (preferably about 20° C. or more, and more preferably about ° C. or more); the elastomer has a hardness (i.e., durometer) of about 90 Shore A or less (as measured according to ASTM D 2240) at a temperature of about 20° C.; the surface layer has a textured outer surface (e.g. having a predetermined texture); the surface layer is characterized by a surface roughness (e.g., mean roughness value, R_{A} and/or measured roughness depth, R_{z}) of about 0.5 μm or more (preferably about 1.0 μm or more, even more preferably about 2.0 μm or more, even more preferably about 4.0 μm or more, even more preferably about 6.0 μm or more, even more preferably about 10 μm or more, and most preferably about 20 μm or more; the surface layer has a thickness of about 400 μm or less (preferably about 250 μm or less, about 150 μm or less, or about 100 μm or less or less and/or a thickness of about 5 μm or more, (preferably about 10 μm or more, about 20 μm or more, about 30 μm or more, about 40 μm or more, about 50 μm or more, or about 60 μm or more; the surface layer includes one or more fillers; the one or more fillers includes glass or ceramic beads; the glass or ceramic beads includes hollow beads; the hollow beads have an average specific gravity of about 0.10 or more, about 0.20 or more, about 0.30 or more, about 0.40 or more, about 0.50 or more, about 0.60 or more about 0.70 or more, or about 0.75 or more; the hollow beads have an average specific gravity of about 2.0 or less, about 1.7 or less, about 1.4 or less, about 1.1 or less, about 1.0 or less, about 0.90 or less, or about 0.80 or less; the glass or ceramic beads have a narrow size distribution (e.g., a ratio of the weight average diameter to the number average diameter is about 2.0 or less, about 1.80 or less, about 1.60 or less, about 1.40 or less, about 1.20 or less, or about 1.10 or less); the glass or ceramic beads have a broad size distribution (e.g., a ratio of the weight average diameter to the number average diameter is more than about 2.0, about 2.5 or more, about 3.0 or more, about 4.0 or more, about 5.0 or more, about 7.0 or more, or about 9.0 or more); a ratio of the specific gravity of the elastomer to a specific gravity of the filler (e.g., glass or ceramic ads or hollow beads) is about 0.20 or more about 0.35 or more, about 0.50 or more, about 0.60 or more, about 0.70 or more, or about 0.75 or more and/or about 2.0 or less, about 1.60 or less, about 1.50 or less, about 1.40 or less, about 1.30 or less, or about 1.25 or less; a ratio of a thickness of the surface layer to a diameter (e.g., maximum diameter or average diameter, such as weight average diameter or number average diameter) of the filler (e.g., the glass or ceramic beads or hollow beads) is about 10 or less, about 7 or less, about 5 or less, about 3 or less, about 2 or less about 1.6 or less, about 1.4 or less, about 1.3 or less, about 1.2 or less, about 1.1 or less, or about 1.0 or less and/or about 0.1 or more, about 0.2 or more, about 0.3 or more, about 0.4 or more, about 0.5 or more, about 0.6 or more, about 0.7 or more, about 0.8 or more, or about 0.9 or more; the article includes a plurality of attachment features for securing (e.g., mechanically securing and/or fastening) the article to a casting (preferably three or more attachment features spaced apart in a non-linear arrangement); about 50 percent or more (preferably about 60 percent or more, 70 percent or more, 80 percent or more, 90 percent or more, or 95 percent or more) of a face surface of the surface layer that faces towards the casting exerts a compressive force on the casting (e.g., as measured using pressure sensitive paper, such as FUJIFILM PRESCALE pressure sensitive paper); the plurality of attachment features includes a plurality of perimeter attachment features spaced apart along a perimeter of the article (e.g. a ratio of 1) a distance from the attachment feature to an edge of the article to 2) a width or length of the article, is about 10% or less, about 5% or less, or about 2% or less); the plurality of attachment features includes one or more attachment features located in a central region of the article (e.g., at least 10% or at least 20% away from an edge of the article, based on the width and or length of the article); one or more of the attachment features is attached with a predetermined force or torque; the elastomer (e.g., of the surface layer) is cross-linked or otherwise cured; the elastomer (e.g., the elastomer of the surface layer) adheres to the first metallic layer or the second metallic layer; the first metallic layer, the second metallic layer, or both has a coating for reducing corrosion of the metallic layer and/or for increase adhesion to the core layer or the surface layer; the first metallic layer and/or the second metallic layer is a galvanized steel (e.g., galvanized cold roll steel); the article has a thickness of about 0.30 mm or more, about 0.50 mm or more, about 0.70 mm or more, or about 0.80 mm or more and/or about 10 mm or less, about 7 mm or less, about 4 mm or less, about 3 mm or less, about 2.0 mm or less, about 1.7 mm or less, about 1.40 mm or less, or about 1.30 mm or less; a ratio of a thickness of the first metallic layer to the second metallic layer to the core layer to the surface layer is about: 3−10:3−10:0:1−1:0.3−2.5; a ratio of the total thickness of the first metallic layer, the second metallic layer, the core layer, and the surface layer to the thickness of the article is about 70% or more (e.g., about 80% or more, about 90% or more, or about 100%); the article consists of the first metallic layer, the second metallic layer, the core layer, and the surface layer; the first metallic layer is a steel (preferably a galvanized steel) having a thickness of about 0.20 to about 1.0 mm (preferably about 0.30 to about 0.70 mm); the second metallic layer is a steel (preferably a galvanized steel having a thickness of about 0.20 to about 1.0 mm (preferably about 0.30 to about 0.70 mm); the core layer contacts the first metallic layer and the second metallic layer (preferably the surface of the galvanized steel) and has a thickness of about 0.01 mm to about 0.20 mm (preferably about 0.015 to about 0.070 mm); the surface layer includes glass or ceramic beads (preferably hollow beads) in the elastomeric composition (preferably having a cross-linked elastomer), has a textured surface and a thickness of about 0.02 mm to about 0.25 mm (preferably 0.04 mm to about 0.15 mm); the article includes a three or more holes or other attachment components for attaching to a casting; the article has a total thickness of about 0.50 to about 2.4 mm (preferably from about 0.7 to about 1.8 mm); the article reduces the maximum value of the noise transfer function in the frequency range of 400 Hz to 800 Hz by about 10 dB or more at one or more of the following temperatures: about 20° C., about 50° C., about 60° C., about 70° C., about 80° C., or about 90° C.

Another aspect according to the teachings herein is directed at a device including a metal casting and a sound damping article (preferably a sound dampening article as described herein), wherein a surface layer of the sound damping article contacts a surface of the metal casting.

This aspect of the teachings may be further characterized by one or any combinations of the following: the surface layer includes a elastomer; the surface layer has a textured surface; the surface layer includes glass or ceramic beads; the sound damping article is attached to the metal casting with a plurality of spaced apart attachment components (e.g., bolts, screws, or other connectors); the sound damping article is attached to an outer surface of the casting; the sound damping article is attached to an inner surface of the casting (preferably wherein the sound damping article is hidden by the casting); about 70 percent or more of a face surface of the surface layer of the sound damping article applies pressure directly to the casting; the surface of the casting in contact with the sound damping article is a painted or unpainted; the sound damping article has a generally flat, planar configuration (preferably wherein the sound damping article is cut from a blank and/or is attached to the casting without a forming step); the casting is an inverter cover, a power train component, or an oil pan; the surface layer of the sound damping article conforms to a surface of the casting and/or applies pressure to the surface of the casting; the surface of the casting is a surface that is an as-cast surface (i.e., without machining); the sound dampening article is a generally planar article; the surface of the casting is a rough surface (e.g., having an R_{A} of about 3 μm or more, about 5 μm or more, about 10 μm or more, or about 20 μm or more); the face surfaces of the sound dampening article are generally planar.

Another aspect according to the teachings herein is the use of a sound damping article (such as described herein) for an automotive application or for a non-automotive application.

Another aspect according to the teachings herein is directed at a method of forming the sound damping article (preferably a sound damping article according to the teachings herein) comprising a step of: coating a surface of one of the metallic layers with a composition including an elastomer and glass or ceramic beads in a carrier fluid; and removing at least a portion of the carrier fluid. The method may include a step of at least partially cross-linking the elastomer (e.g., for increasing a molecular weight of the elastomer, for forming long chain or short chain branches, for increasing the viscosity of the elastomer, for forming a network structure, or any combination thereof).

### BRIEF DESCRIPTION OF THE DRAWINGS

FIG. 1 is a perspective view of an illustrative sound damping article according to the teachings herein.

FIG. 2 is a top view of the sound damping article.

FIG. 3 is a graph showing the noise transfer function vs. frequency for a casting (i.e., bare casting) and for the casting having a sound damping article attached. As illustrated in FIG. 3, the maximum value of the NTF in the range of 400 to 800 Hz (e.g., primary mode) is about 91 for the casting. With the sound damping article the maximum NTF in the range of 400 to 800 Hz is about 75 (i.e., a reduction of about 16 dB).

### DETAILED DESCRIPTION

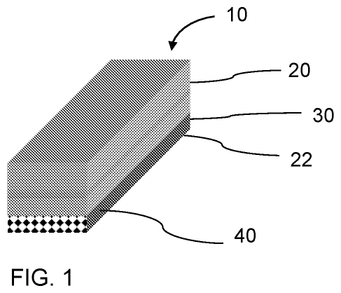

The sound damping articles according to the teachings herein are composite materials including at least one metallic layer and a surface layer including an elastomer. The composite material preferably includes two or more metallic layers. As illustrated in FIG. 1, the composite material 10 may include a first metallic layer 20 and a second metallic layer 22. The first metallic layer preferably is an outer layer of the composite. The composite material 10 includes a surface layer 40 that includes an elastomer. The surface layer is an outer layer of the composite material. In use, the surface layer will typically contact a casting. The composite material preferably includes a core layer 30 interposed between the first metallic layer and the second metallic layer.

### Metallic Layer

The composite material of the sound damping article includes two or more metallic layers. The metallic layers assist in applying a compressive force to the surface of the casting. The metallic layers may be formed of the same or different metal layers. If the thickness of the metallic layers (individually or combined) is too high, the sound damping article will heavy and costly. If the thickness of the metallic layers is too low, there may be insufficient compressive force between the surface layer of the sound damping article and the casting and the sound damping properties will be lacking.

The first metallic layer and the second metallic layer may be formed of any metallic material that can be formed into a sheet, foil, or film. Each of the metallic layer includes or consists of one or more metal atoms. The concentration of metal atoms in the metal layer preferably is about 30 atomic percent or more, about 40 atomic percent or more, about 50 atomic percent or more, about 60 atomic percent or more, about 70 percent or more, about 80 percent or more, or about 90 percent or more, based on the total number of atoms in the metallic layer. The concentration of metal atoms in the metallic layer may be about 100 atomic percent or less, about 95 atomic percent or less, or about 90 atomic percent or less. Preferred metallic layers include aluminum or iron atoms. The concentration of iron and/or aluminum atoms in the metallic layer preferably is about 50 percent or more, about 60 percent or more, about 70 percent or more, or about 85 percent or more, based on the total number of metal atoms in the metallic layer. Preferred metals include steel and aluminum. The first and second metallic layers may be formed of the same material or from different materials. Preferably, the first and second metallic layers are formed from the same material. For example, the first and second metallic layers may be formed from the same grades of steel or from different grades of steel. As another example, the first and second metallic layers may be formed from the same aluminum alloy or may be formed from different aluminum alloys. It is also possible that one of the metallic layers is formed of a steel and the other is formed of a non-ferrous metal. It is also possible that one of the metallic layers is formed of an aluminum, and the other metallic layer is formed of a non-aluminum metal. For example, one metallic layer may include a steel layer and the other metallic layer may include an aluminum layer. The first metallic layer, the second metallic layer or both may include (e.g., about 30% or more, about 40% or more, or about 50% or more, by weight), consist essentially of (e.g., about 70% or more, about 80% or more, or about 90% or more, by weight), or consist entirely of a metallic material that is corrosion resistant. An example of a corrosion resistant metallic material is stainless steel. The first metallic layer, the second metallic layer or both may be formed of a metallic material which is capable of corroding (e.g., a material which corrodes more than stainless steel when immersed in water). For example, the first metallic layer, the second metallic layer, or both may include a steel alloy and/or non-ferrous metal alloy 2006 having high corrosivity compared with stainless steel (e.g. Type 304 stainless steel (ASTM A240), or A2 stainless steel according to ISO 3506). The first metallic layer, the second metallic layer, or both may include one or more surfaces (e.g., face surfaces and/or edge surfaces) that are coated or treated so that the corrosion resistance of the metallic layer is improved. For example, one or more, or all of the face and/or edge surfaces of the first metallic layer, the second metallic layer may have a phosphorous-containing coating or treatment.

The first metallic layer and the second metallic layers preferably are formed from metallic sheets. The metallic sheets preferably are provided as rolls so that a roll of the composite material can be produced. The first metallic layer and the second metallic layer may have the same thickness or may have different thickness. Preferably a ratio of the thickness of the two metallic layer (i.e., the thinnest metallic layer to the thickest metallic layer) is about 0.1 or more, about 0.2 or more, about 0.4 or more, about 0.50 or more, about 0.75 or more, about 0.8 or more, or about 0.90 or more. A ratio of the thickness of the two metallic layers may be about 1.00 or less. It will be appreciated that in some applications it may be desirable for the first metallic layer (e.g., on the inner side of the tube) to have a wall thickness greater than the wall thickness of the second metallic layer (e.g., on the outer side of the tube). In other applications, it may be desirable for the second metallic layer to have a wall thickness greater than a wall thickness of the first metallic layer. Preferably, the total thickness of the first and second metallic layers is about 0.30 mm or more, more preferably about 0.40 mm or more, even more preferably about 0.50 mm or more, even more preferably about 0.65 mm or more, and most preferably about 0.80 mm or more. The total thickness of the first and second metallic layers preferably is about 7.0 mm or less, more preferably about 5.0 mm or less, even more preferably about 3.0 mm or less, even more preferably about 1.8 mm or less, and most preferably about 1.3 mm or less.

One of the metallic layer (e.g., the first metallic layer or first metal sheet) preferably is an outer layer of the sound damping article. In use, this metallic layer typically is positioned away from the casting. The other metallic layer (e.g., the second metallic layer or the second metal sheet) preferably is interposed between the core layer and the surface layer. The composite materials according to the teachings herein preferably includes at least the first metallic layer, the second metallic layer, the core layer, and the surface layer. Although the composite material may include one or more additional layers, the use of the core layer, the surface layer and the metallic layers, may eliminate the need any other layers.

The metal layers may have one or more surfaces plated or coated (e.g., with a thin film), or having one or more other surface treatment (e.g., a treatment that cleans, etches, roughens, or chemically modifies a surface). A metal face may have one or more coatings, platings or surface treatments that improves the adhesion of a filled polymeric material to the metal layer. The metal layers may have one or more surfaces plated, coated or otherwise treated that provides corrosion resistance, improves adhesion to a paint or primer, improves stiffness, or any combination thereof. Exemplary coatings and platings may include one or any combination of galvanized, electrogalvanized, chrome plating, nickel plating, corrosion resistance treatment, e-coat, zinc coated, Granocoat, Bonazinc and the like. It will be appreciated that one or more coatings, platings, or surface treatments may be performed on the composite material, (e.g., after the composite material is prepared). As such, a surface of the metal layer facing the filled polymeric layer may be free of a coating, plating or surface treatment and an exposed surface of the metal layer may have a coating, plating or surface treatment. One or both metal faces may be free of a coating, plating or surface treatment (for example, the filled polymeric material may be treated or selected so that it provides good adhesion to the metal layer without the need for a coating, plating, or surface treatment).

### Core Layer

The core layer(s) provides a separation between the two metallic layers. The core layer, preferably reduces or eliminates transmission of sound and/or heat between the two metallic layers. The core layer preferably includes one or more non-metallic material. The amount of non-metallic material in the core layer may be about 50 volume percent or more, about 70 volume percent or more, 80 volume percent or more, about 90 volume percent or more, or about 95 volume percent or more, based on the total volume of the core layer. The amount of non-metallic material in the core layer may be about 100 volume percent or less, or about 99 volume percent or less. Examples of materials that may be employed in the core layer include polymers, oligomers, cross-linkable and/or polymerizable compounds, glasses, ceramic materials, woven or non-woven fabrics, organic materials, clays, mineral fillers, or any combination thereof. The core layer preferably includes a polymer or other viscoelastic material capable of absorbing sound, reducing or preventing the transfer of sound, or both.

The core layer(s) preferably fills a substantial amount of the space between the first and second metallic layers. Preferably the core layer material fills about 30% or more of the volume, more preferably about 50% or more of the volume, even more preferably about 75% or more of the volume, even more preferably about 90% or more of the volume, and most preferably about 95% or more of the volume between the first and second metallic layers. The amount of any voids in the core layer and/or between the metallic layers may be about 70 volume percent or less, about 50 volume percent or less, about 25 volume percent or less, about 10 volume percent or less or about 5 volume percent or less, based on the total volume between the first and second metallic layers.

The thickness of the core layer preferably is about 0.50 mm or less, more preferably about 0.25 mm or less, even more preferably about 0.15 mm or less, even more preferably about 0.10 mm or less, even more preferably about 0.07 mm or less, and most preferably about 0.05 mm or less. The thickness of the core layer preferably is about 0.005 mm or more, about 0.010 mm or more, about 0.015 mm or more, about 0.020 mm or more, or about 0.025 mm or more.

### Materials for the Core Layer

The core layer(s) may include or be formed of a polymeric material (i.e., polymeric composition) that includes, consists essentially of, or consists entirely of one or more polymers. Preferably, the amount of the polymer in the core layer is about 30 weight percent or more, more preferably about 50 weight percent or more, even more preferably about 80 weight percent or more, and most preferably about 90 weight percent, based on the total weight of the core layer and/or based on the total weight of the polymeric composition. The core layer preferably includes one or more polymers having a generally low hardness. As used herein, polymer having a generally low hardness may be characterized by a Shore A durometer (measured according to ASTM D2240) of about 90 Shore A or less, preferably about 75 Shore A or less, and more preferably about 65 Shore A or less). Preferably the core layer includes a polymer having a hardness of about 10 Shore A or more (e.g., about 20 Shore A or more, or about 30 Shore A or more). The polymer of the core lay may have a crystallinity (e.g., as measured by differential scanning calorimetry according to ASTM D3418) of about 60% or less, about 50% or less, about 40% or less, about 30% or less, about 20% or less, or about 10% or less. For example, the polymer may be a generally amorphous polymer having a crystallinity of about 5% or less or about 0%. The core layer may include a filler at a concentration of 3 wt. % or more, or may be substantially free (i.e., a filler concentration of less than 3 weight percent, or about 1 weight percent or less) or may be entirely free of filler. The polymeric material of the core layer preferably includes an elastomeric material. A particularly preferred elastomeric material is an acrylic elastomer. The polymeric material (i.e., the polymeric composition of the core layer) may be formed from a composition that includes one or more components for cross-linking an elastomer. For example, the polymeric material may include a cross-linking agent, a cross-linking activator, a cross-linking accelerator, or any combination thereof. As such, the polymeric material may include a cross-linked elastomer. The polymeric material may include a generally high molecular weight polymer (e.g., having a molecular weight of about 30,000 or more, about 80,000 or more, or about 200,000 or more). The polymeric material may be selected to provide adhesion to the first and/or second metallic layers and/or an adhesive or other bonding agent may be employed for improving adhesion between the polymeric material and a metallic layer.

The multi-layer composite and/or the sound damping article preferably has a uniform thickness (except for the textured surface of the surface layer). For example, a large portion (e.g., 60% or more, 70% or more, 80% or more, 90% or more, or about 100%) of the composite may have a thickness, t, that is within a range of t1≤t≤t2, where (i) the ratio of t2/t1 is about 1.50 or less, about 1.40 or less, about 1.30 or less, about 1.20 or less, about 1.10 or less, or about 1.05 or less and/or the difference between t2−t1 is about 0.30 mm or less, about 0.20 mm or less, about 0.15 mm or less, about 0.10 mm or less, about 0.07 mm or less, about 0.05 mm or less, about 0.03 mm or less, about 0.02 mm or less, or about 0.01 mm or less. The ratio of t2/t1 may be about 1.00 or more and/or the of t2-t1 may be about 0.00 or more.

The surface layer may be smooth or may be a rough surface layer. The surface layer preferably is configured and/or arranged for contacting the casting. The surface layer preferably has a rough surface.

The surface layer includes an elastomeric composition having a glass transition temperature of about 10° C. or less, a crystallinity of about 5 percent or less at 23° C., or both. Preferably the elastomeric composition includes one or more elastomers. The elastomer may be any elastomer having a low glass transition temperature and/or low crystallinity. Without limitation, the elastomer may be an ethylene copolymer (e.g., having a comonomer that is an olefin and/or a comonomer that includes one or more heteroatoms), a polyisoprene, a polybutadiene, an ethylene propylene diene rubber, a silicone elastomer, a fluoroelastomer, a natural rubber, a styrene-butadiene block copolymer, a polyurethane elastomer, an polyacrylic rubber, an epichlorohydrin rubber, polyether block amide, an ethylene-vinyl acetate rubber, a chloroprene rubber, a halogenated butyl rubber, a hydrogenated nitrile rubber, a nitrile rubber, a copolymer thereof, or any combination thereof. The elastomer preferably is free of any melting temperature or glass transition temperature of about 35° C. or more (preferably about 20° C. or more, and more preferably about ° C. or more). The elastomer preferably has a hardness (i.e., durometer) of about 90 Shore A or less (as measured according to ASTM D 2240) at a temperature of about 20° C., preferably the elastomer has a hardness of about 80 Shore A or less, about 70 Shore A or less, about 60 Shore A or less, about 50 Shore A or less, or about 40 Shore A or less.

The elastomeric layer may include one or more fillers. Preferably the elastomeric layer includes glass or ceramic beads. The glass or ceramic beads may be solid or hollow. Preferably the elastomeric layer includes beads that are hollow. The beads may have an average specific gravity of about 0.10 or more, about 0.20 or more, about 0.30 or more, about 0.40 or more, about 0.50 or more, about 0.60 or more about 0.70 or more, or about 0.75 or more. The beads may have an average specific gravity of about 3.0 or less, about 2.2 or less, about 2.0 or less, about 1.7 or less, about 1.4 or less, about 1.1 or less, about 1.0 or less, about 0.90 or less, or about 0.80 or less. The glass or ceramic beads may have a narrow size distribution (e.g., a ratio of the weight average diameter to the number average diameter is about 2.0 or less, about 1.80 or less, about 1.60 or less, about 1.40 or less, about 1.20 or less, or about 1.10 or less). In one preferred aspect, the beads (e.g., the glass or ceramic beads) have a broad size distribution (e.g., a ratio of the weight average diameter to the number average diameter is more than about 2.0, about 2.5 or more, about 3.0 or more, about 4.0 or more, about 5.0 or more, about 7.0 or more, or about 9.0 or more). In particular, it may be advantageous to choose the filler so that a portion of the filler has a diameter that is equal to or less than the average thickness of the surface layer and a portion of the filler has a diameter that is greater than the average thickness of the surface layer. As such, the filler may contribute to or provide a desired texture or surface roughness to the surface layer. Preferably the amount of the filler that has a diameter greater than the average thickness of the surface layer is about 3 volume percent or more, more preferably about 5 volume percent or more, even more preferably about 10 volume percent or more, and most preferably about 20 volume percent or more. Preferably the amount of the filler that has a diameter greater than the average thickness of the surface layer is about 80 volume percent or less, more preferably about 65 volume percent or less, even more preferably about 50 volume percent or less, and most preferably about 40 volume percent or less.

The concentration of the one or more fillers (e.g., beads) in the surface layer may be about 5 volume percent or more, about 10 volume percent or more about 20 volume percent or more, about 30 volume percent or more, or about 40 volume percent or more and/or about 70 volume percent or less, or about 60 volume percent or less, based on the total volume of the surface layer. A ratio of a thickness of the surface layer to a maximum diameter or average diameter (e.g., weight average diameter or number average diameter) of the filler (e.g., the glass or ceramic beads or hollow beads) preferably is about 10 or less, about 7 or less, about 5 or less, about 3 or less, about 2 or less about 1.6 or less, about 1.4 or less, about 1.3 or less, about 1.2 or less, about 1.1 or less about 1.0 or less and/or about 0.20 or more, about 030 or more, about 0.40 or more, about 0.50 or more, about 0.60 or more, about 0.75 or more, or about 0.9 or more.

A ratio of the specific gravity of the elastomer to a specific gravity of the filler (e.g., glass or ceramic beads or hollow beads) preferably is about 0.20 or more about 0.35 or more, about 0.50 or more, about 0.60 or more, about 0.70 or more, or about 0.75 or more and/or about 3.0 or less, about 2.0 or less, about 1.60 or less, about 1.50 or less, about 1.40 or less, about 1.30 or less, or about 1.25 or less.

The elastomeric layer may include one or more additives for curing or cross-linking the elastomer. For example, the elastomeric layer may include a curative or other cross-linking agent, a cure accelerator, a cure initiator, or any combination thereof.

The composite material, when contacted with a casting, reduces noise from the casting. Preferably the acoustical damping performance is characterized by a reduction in the noise transfer function, such that the maximum noise transfer function in the 400 Hz to 800 Hz range is reduced by about 6 dB or more, preferably reduced by about 8 dB or more, even more preferably reduced by about 10 dB or more, even more preferably reduced by about 12 dB or more, and most preferably reduced by about 14 dB or more. The noise transfer function may be measured as a spatial average noise transfer function. In the 400 Hz to 800 Hz range, a primary vibration mode may be evident. The reduction in NTF at higher modes may be about 3 dB or more, about 4 dB or more, about 6 dB or more, about 8 dB or more, or about 9 dB or more. The reduction in NTF preferably is maintained at temperatures of about 50° C. to about 90° C. (e.g., at about 50° C., about 60° C., about 70° C., about 80° C., or about 90° C. The reduction in NTF preferably is maintained at temperatures of about 20° C.

### Coefficient of Friction

If the coefficient of friction is too low, the sound damping characteristics are not sufficient. If the coefficient of friction is too high, the materials may be difficult to handle. The surface layer preferably is selected so that the static coefficient of friction is about 0.120 or more, about 0.150 or more, about 0.180 or more, about 0.210 or more, about 0.240 or more, or about 0.270 or more, or about 0.300 or more. Most preferably the static coefficient of friction is about 0.310 or more. The surface layer preferably is selected so that the static coefficient of friction is about 0.800 or less, about 0.700 or less, about 0.600 or less, about 0.500 or less, about 0.450 or less, or about 0.400 or less. Most preferably the static coefficient of friction is about 0.390 or less. The surface layer preferably is selected so that the kinetic coefficient of friction is about 0.120 or more, about 0.150 or more, about 0.180 or more, about 0.210 or more, about 0.240 or more, or about 0.270 or more. Most preferably the kinetic coefficient of friction is about 0.280 or more. The surface layer preferably is selected so that the static coefficient of friction is about 0.800 or less, about 0.700 or less, about 0.600 or less, about 0.500 or less, about 0.450 or less, or about 0.400 or less, or about 0.350 or less. Most preferably the static coefficient of friction is about 0.320 or less. The coefficient of friction of the composite material may be tested with an I-Mass SP-2000 (commercially available from IMASS INC., Accord, MA, USA). The coefficient friction is measured with the surface layer including the elastomer in contact with a substrate. A sled is moved across the surface layer. A load of about 0.6 kg is applied. The speed of the sled is about 6 inches/minute. Measurements are made with 5 second averaging and a 1.0 second delay. The coefficient of friction (static and/or kinetic) may be measured according to ASTM D 1894-14. The coefficient of friction may be measured at room temperature (e.g., at about 20° C., about 23° C., or about 25° C.), at elevated temperature (e.g., about 40° C., or about 50° C., or about 60° C.), at subambient temperatures (e.g., about 10° C., about 0° C., about −10° C., or about −20° C.). The coefficient of friction may be measured for a composite material having a surface layer thickness of about 2.6 mils (i.e., about 66 μm). It is particularly desirable that the above described coefficient of friction be achieved and/or maintained at subambient temperatures so that good sound damping performance is achieved under cold conditions. The elastomer (e.g., elastomer type and/or cross-link concentration) may be selected so that the coefficient of friction is achieved. For example, the elastomer (before cure and/or after cure) may be characterized by a glass transition temperature of about 10° C. or less, about 0° C. or less, about −10° C. or less, about −20° C. or less, about −30° C. or less, about −40° C. or less, or about −50° C. or less. The concentration of elastomer in the surface layer (e.g., in the elastomeric composition) may be selected to provide the desired coefficient of friction.

The core layer and/or the surface layer (i.e., damping surface) preferably are dense materials having little or no voids. Preferably the core layer has a void concentration of about 20 volume percent or less, about 10 volume percent or less, about 4 volume percent or less, about 2 volume percent or less, about 1 volume percent or less, about 0.5 volume percent or less, or about 0 volume percent, based on the total volume of the core layer. Preferably the surface layer has a void concentration of about 20 volume percent or less, about 10 volume percent or less, about 4 volume percent or less, about 2 volume percent or less, about 1 volume percent or less, about 0.5 volume percent or less, or about 0 volume percent, based on the total volume of the surface layer.

The composite material (e.g., sound damping component) may be used to reduce sound transmitted from a casting. Preferably, the composite material is attached to the casting with the surface layer (i.e., damping surface) facing the casting. The surface layer preferably directly contacts the casting. The composite material may be attached to the casting using a plurality of attachment components that provide a compressive force between the composite material and the casting. Preferably attachment components are spaced apart and/or present in sufficient number so that a large portion of the surface area of the surface layer contacts the casting. For example, the percentage of the surface area of the surface layer that contacts (e.g., compressively contacts) the casting is about 30% or more, about 40% or more, about 50% or more, about 60% or more, about 70% or more, about 80% or more, or about 90% or more, based on the total surface are of the surface layer facing the casting. The percentage of the surface area of the surface layer that contacts (e.g., compressively contacts) the casting may be about 100% or less. The area of contact (e.g., compressive contact) between the surface layer and the casting may be measured using a pressure sensitive paper (e.g., FUJIFILM PRESCALE® pressure sensitive paper).

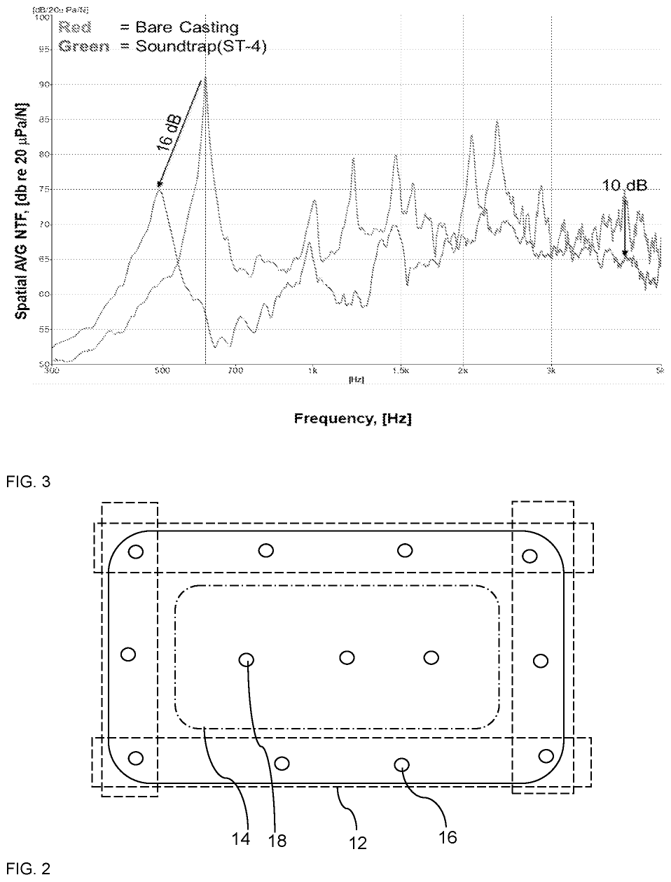

With reference to FIG. 2, the sound damping article may include spaced apart attachment components or features 16, 18. The sound damping article may include attachment components or attachment features 16 positioned near a periphery region 12 of the sound damping article. The sound damping article may include attachment components or attachment features 18 positioned near a central region 14 of the sound damping article.

The sound damping article may have a generally planar shape, such as illustrated in FIG. 1.

The composite material and sound damping articles according to the teachings herein maintain good performance even after exposure to oils, transmission fluid, alkaline cleaners, acidic environments, or combination thereof.

### General Information Applicable to the Teachings

It is to be understood that the disclosed embodiments are merely exemplary of the teachings that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present teachings.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

Any numerical values recited herein include all values from the lower value to the upper value in increments of one unit provided that there is a separation of at least 2 units between any lower value and any higher value. As an example, if it is stated that the amount of a component or variable is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight, and vice versa. Thus, an expression in the Detailed Description of the Invention of a range in terms of at “‘x’ parts by weight of the resulting composition” also contemplates a teaching of ranges of same recited amount of “x” in percent by weight of the resulting composition. Relative proportions derivable by comparing relative parts or percentages are also within the teachings, even if not expressly recited.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consisting of, the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

Relative positional relationships of elements depicted in the drawings are part of the teachings herein, even if not verbally described. Further, geometries shown in the drawings (though not intended to be limiting) are also within the scope of the teachings, even if not verbally described.

### Examples

A composite sound damping article is prepared with a polymeric core layer (thickness of about 0.03 mm) between two layers of galvanized cold rolled steel (thickness of about 0.050 mm each). The composite includes a surface layer of an elastomeric composition directly attached to one of layers of galvanized CRS. The surface layer has a textured outer surface for contacting with a casting. The total thickness is about 1.11 mm. The elastomer in the surface layer is heated and cross-linked. The elastomeric composition includes ceramic beads having a. The areal density of the composite material is about 1.82 lbs/ft².

Acoustical damping performance is measured (at room temperature of about 20° C.) for a bare casting (without the sound damping article) and with the composite material attached. The sound damping article is attached to casting using spaced apart bolts with the surface layer directly contacting the casting. The bolts are tightened to a predetermined torque. Pressure sensitive paper shows that the entire surface of the sound damping article applies pressure to the casting. The acoustical performance is shown in FIG. 3. Without the sound damping article, the casting has a maximum noise transfer function of about 91 dB in the frequency range of 400 to 800 Hz. With the sound dampening article attached to the casting, the maximum of the noise transfer function in the range of 400 to 800 Hz is about 75 dB. The reduction in the maximum NTF is about 16 dB. At higher frequency modes, the reduction in the NTF is about 10 dB.

The acoustical dampening performance is measured at a temperature of about 50° C. and similar reductions in the NTF are expected. The acoustical dampening performance is measured at a temperature of about 60° C. and similar reductions in the NTF are expected. The acoustical dampening performance is measured at a temperature of about 70° C. and similar reductions in the NTF are expected. The acoustical dampening performance is measured at a temperature of about 80° C. and similar reductions in the NTF are expected. The acoustical dampening performance is measured at a temperature of about 90° C. and similar reductions in the NTF are expected.

The composite material is expected to have a peel resistance of about 2.6 N/mm or more and/or a shear resistance of about 2.4 MPa or more.

The composite material is expected to have good resistance to oils, transmission fluid, alkaline cleaners, acidic environments, or any combination thereof.

The composite material, after heating to 110° C. for about 1006 hours, is expected to have no signs of delamination or loss of sound damping performance.

The concentration of voids in the core layer is expected to be about 1 volume percent or less.

The concentration of any voids in the surface layer is expected to be about 1 volume percent or less.

What is claimed is:

1. A sound damping article for attaching to a casting comprising a multi-layer composite including:
a) a first metallic layer;
b) a second metallic layer;
c) one or more core layers interposed between the first metallic layer and the second metallic layer so that direct contact between the first metallic layer and the second metallic layer is avoided, wherein each of the one or more core layers is formed of a polymeric material; and
d) a surface layer (i.e, damping surface) for contacting the casting, wherein the surface layer is an outer layer over the first metallic layer or the second metallic layer, wherein the surface layer includes an elastomeric composition having a glass transition temperature of about 10° C. or less, a crystallinity of about 5 percent or less at 23° C., or both.

2. The article of claim 1, wherein the elastomeric composition includes an elastomer characterized by one or any combination of the following:
i) the elastomer is an ethylene copolymer (e.g., having a comonomer that is an olefin and/or a comonomer that includes one or more heteroatoms), a polyisoprene, a polybutadiene, an ethylene propylene diene rubber, a silicone elastomer, a fluoroelastomer, a natural rubber, a styrene-butadiene block copolymer, a polyurethane elastomer, a polyacrylic rubber, an epichlorohydrin rubber, polyether block amide, an ethylene-vinyl acetate rubber, a chloroprene rubber, a halogenated butyl rubber, a hydrogenated nitrile rubber, a nitrile rubber, a copolymer thereof, or any combination thereof; and/or
ii) the elastomer is free of any melting temperature or glass transition temperature of about 35° C. or more (preferably about 20° C. or more, and more preferably about ° C. or more); and/or
iii) the elastomer has a hardness (i.e., durometer) of about 90 Shore A or less (as measured according to ASTM D 2240) at a temperature of about 20° C.

3. The article of claim 1, wherein
the surface layer has a textured outer surface (e.g. a predetermined texture); or
the surface layer is characterized by a surface roughness (e.g., mean roughness value, R_{A} and/or measured roughness depth, R_{z}) of about 0.5 μm or more (preferably about 1.0 μm or more, even more preferably about 2.0 μm or more, even more preferably about 4.0 μm or more, even more preferably about 6.0 μm or more, even more preferably about 10 μm or more, and most preferably about 20 μm or more; or
the surface layer has a thickness of about 400 μm or less (preferably about 250 μm or less, about 150 μm or less, or about 100 μm or less or less and/or a thickness of about 5 μm or more, (preferably about 10 μm or more, about 20 μm or more, about 30 μm or more, about 40 μm or more, about 50 μm or more, or about 60 μm or more.

4. (canceled)

5. (canceled)

6. The article of claim 1, wherein the surface layer includes one or more fillers.

7. The article of claim 6, wherein the one or more fillers includes glass or ceramic beads.

8. The article of claim 7,
wherein the glass or ceramic beads includes hollow beads;
optionally wherein the hollow beads have an average specific gravity of about 0.10 or more, about 0.20 or more, about 0.30 or more, about 0.40 or more, about 0.50 or more, about 0.60 or more about 0.70 or more, or about 0.75 or more;
optionally wherein the hollow beads have an average specific gravity of about 2.0 or less, about 1.7 or less, about 1.4 or less, about 1.1 or less, about 1.0 or less, about 0.90 or less, or about 0.80 or less.

9. (canceled)

10. (canceled)

11. The article of claim 7, wherein the glass or ceramic beads have a narrow size distribution (e.g., a ratio of the weight average diameter to the number average diameter is about 2.0 or less, about 1.80 or less, about 1.60 or less, about 1.40 or less, about 1.20 or less, or about 1.10 or less).

12. (canceled)

13. The article of claim 6,
wherein a ratio of the specific gravity of the elastomer to a specific gravity of the filler is about 0.20 or more about 0.35 or more, about 0.50 or more, about 0.60 or more, about 0.70 or more, or about 0.75 or more and/or about 2.0 or less, about 1.60 or less, about 1.50 or less, about 1.40 or less, about 1.30 or less, or about 1.25 or less; or
a ratio of a thickness of the surface layer to a number average diameter of the filler is about 10 or less, about 7 or less, about 5 or less, about 3 or less, about 2 or less about 1.6 or less, about 1.4 or less, about 1.3 or less, about 1.2 or less, about 1.1 or less about 1.0 or less and/or about 0.20 or more, about 030 or more, about 0.40 or more, about 0.50 or more, about 0.60 or more, about 0.75 or more, or about 0.9 or more.

14. (canceled)

15. The article of claim 1,
wherein the article includes a plurality of attachment features for securing the article to a casting;
optionally wherein the plurality of attachment features includes three or more attachment features spaced apart in a non-linear arrangement;
optionally wherein about 50 percent or more of a face surface of the surface layer that faces towards the casting exerts a compressive force on the casting;
optionally wherein the plurality of attachment features includes a plurality of perimeter attachment features spaced apart along a perimeter of the article;
optionally wherein the plurality of attachment features includes one or more attachment features located in a central region of the article at least 10% or at least 20% away from an edge of the article;
optionally wherein one or more of the attachment features is attached with a predetermined force or torque.

16. (canceled)

17. (canceled)

18. (canceled)

19. (canceled)

20. The article of claim 1,
wherein the elastomer is cross-linked or otherwise cured; or
wherein the elastomer adheres to the first metallic layer or the second metallic layer; or
wherein the first metallic layer, the second metallic layer, or both has a coating for reducing corrosion of the metallic layer.

21. (canceled)

22. (canceled)

23. (canceled)

24. The article of claim 1,
wherein the article has a thickness of about 0.30 mm or more, about 0.50 mm or more, about 0.70 mm or more, or about 0.80 mm or more and/or about 10 mm or less, about 7 mm or less, about 4 mm or less, about 3 mm or less, about 2.0 mm or less, about 1.7 mm or less, about 1.40 mm or less, or about 1.30 mm or less; or
wherein a ratio of a thickness of the first metallic layer to the second metallic layer to the core layer to the surface layer is about:
3−10:3−10:0.1−1:0.3−2.5; or
wherein a ratio of the total thickness of the first metallic layer, the second metallic layer, the core layer, and the surface layer to the thickness of the article is about 70% or more.

25. (canceled)

26. (canceled)

27. The article of claim 1, wherein the article consists of the first metallic layer, the second metallic layer, the core layer, and the surface layer.

28. The article of claim 1, wherein:
the first metallic layer is a steel (preferably a galvanized steel) having a thickness of about 0.20 to about 1.0 mm (preferably about 0.30 to about 0.70 mm);
the second metallic layer is a steel (preferably a galvanized steel having a thickness of about 0.20 to about 1.0 mm (preferably about 0.30 to about 0.70 mm);
the core layer contacts the first metallic layer and the second metallic layer (preferably the surface of the galvanized steel) and has a thickness of about 0.01 mm to about 0.20 mm (preferably about 0.015 to about 0.070 mm); and
the cover layer includes glass or ceramic beads (preferably hollow beads) in the elastomeric composition (preferably having a cross-linked elastomer), has a textured surface and a thickness of about 0.02 mm to about 0.25 mm (preferably 0.04 mm to about 0.15 mm);
the article includes a three or more holes or other attachment components for attaching to a casting; and
the article has a total thickness of about 0.50 to about 2.4 mm (preferably from about 0.7 to about 1.8 mm).

29. The article of claim 1, wherein the article reduces the maximum value of the noise transfer function in the frequency range of 400 Hz to 800 Hz by about 10 dB or more at one or more of the following temperatures: about 20° C., about 50° C., about 60° C., about 70° C., about 80° C., or about 90° C.

30. A sound damping article, wherein the sound damping article is formed of a composite material, the sound damping article is configured for attaching to a casting, the composite material includes a metallic layer (preferably two or more metallic layers) and a surface layer including an elastomer and glass or ceramic beads, wherein the sound damping article results in a reduction in the maximum value of the noise transfer function in the frequency range of 400 Hz to 800 Hz by about 10 dB or more at one or more of the following temperatures: about 20° C., about 50° C., about 60° C., about 70° C., about 80° C., or about 90° C.

31. A device including a metal casting and a sound damping article of claim 1, wherein the surface layer of the sound damping article contacts a surface of the metal casting;
optionally, wherein the sound damping article is attached to the metal casting with a plurality of spaced apart attachment components.

32. (canceled)

33. The device of claim 31, wherein
the sound damping article is attached to an outer surface of the casting; or
the sound damping article is attached to an inner surface of the casting; or
about 70 percent or more of a face surface of the surface layer of the sound damping article applies pressure directly to the casting; or
the surface of the casting in contact with the sound damping article is painted; or
the sound damping article has a generally flat, planar configuration; or
the casting is an inverter cover, a power train component, or an oil pan.

34. (canceled)

35. (canceled)

36. (canceled)

37. (canceled)

38. (canceled)

39. The device of claim 31,
wherein the surface layer of the sound damping article conforms to a surface of the casting and/or applies pressure to the surface of the casting,
i) wherein the surface of the casting is a surface that is an as-cast surface (i.e., without machining), and wherein the sound dampening article is a generally planar article; or
ii) wherein the surface of the casting is a rough surface, and wherein the face surfaces of the sound dampening article are generally planar.

40. (canceled)

41. An automotive device comprising the sound damping article of claim 1.

42. (canceled)

43. A method of forming the sound damping article of claim 1, the method comprising a step of:
coating a surface of one of the metallic layers with a composition including an elastomer and glass or ceramic beads in a carrier fluid; and
removing at least a portion of the carrier fluid;
optionally, wherein the method includes a step of at least partially cross-linking the elastomer.

44. (canceled)
